(19) United States
(12) Patent Application Publication
(10) Pub. No.: US 2002/0076949 A1
(43) Pub. Date: Jun. 20, 2002

(54) Garment component

(76) Inventors: Nancy A. Tilbury, London (GB); Juliette Allen, London (GB); Kyriakos J. Mama, Brighton (GB); Jenni L. Arksey, London (GB); George Marmaropoulos, New York, NY (US)

Correspondence Address: Jack E. Haken, U.S. Philips Corporation, 580 White Plains Road, Tarrytown, NY, 10591, US

(21) Appl. No.: 09/878,989

(22) Filed: Jun. 12, 2001

(30) Foreign Application Priority Data
Dec. 6, 2000 (GB) 0014327.1

(51) Int. Cl. H01R 33/00

(52) U.S. Cl. 439/37

(57) ABSTRACT

A wiring structure for incorporation into garments allows electrical or electronic equipment carried about the person to be connected together. The cabling structure comprises cabling of electrical conductors or optical fibres and cabling terminations in the form of connector components. The connector components facilitate connection and disconnection with the electrical or electronic equipment and in order to do so are provided in the finished garment at accessible locations. The cable terminations are mounted on fabric portions allowing attachment with garments using traditional garment construction techniques. A fabric carrier piece may be provided.

The present invention relates to a cabling structure for use in garments and in particular to a cabling structure for interconnection of devices.

The task of integrating or fitting electrical and electronic apparatus within clothing presents a number of problems to the designer. When more than one piece of apparatus is provided, or when equipment is spatially distributed as sub-components, there may be a requirement for the devices to communicate with each other. This can be done using conventional wires spanning between apparatus or components, but the resulting trailing or hanging wires are unsightly, inconvenient and when carried about the person can easily lead to accidents causing damage to the apparatus or user.

An example of a garment of the type recited in the opening paragraph is given in U.S. Pat. No. 5,148,002 (Kuo et al) which describes a multi-functional garment comprised of an outer shell garment and a number of electronic modules, including heating, communications and display devices.

A further example of a garment of the type recited in the opening paragraph is given in U.S. Pat. No. 4,539,700 (Sato) which describes a personal portable audio device in the form of a garment having a number of pockets for receiving components of the system, with a pair of speakers for reproduction of the audio being provided in the left and right shoulder portions of the garment: the wiring from the audio signal source component to the speakers is hidden within the garment construction, including connectors within the pockets for establishing electrical connection to a device placed therein.

It is an object of the present invention to provide a way to interconnect such apparatus that will not suffer from the problems of trailing wires.

In accordance with a first aspect of the present invention there is provided a transmission cabling structure for use in garments, said structure including at least one cable portion and at least one cabling termination wherein the termination is mounted on a fabric portion. By mounting the terminations on fabric portions the terminations may be easily fixed to garments by attaching the fabric portion to the garment using traditional garment construction techniques. The at least one termination may comprise a connector component. In this case, the connector component can serve to facilitate electrical or optical connection to be established with an at least one of the cabling portions.

Thus by providing a cabling structure for use in garments, the cabling structure can be used to connect together the various pieces of apparatus being carried by a person. Because the garment is provided with the cabling structure the at least one cable portion can be routed within the garment thereby avoiding the occurrence of trailing wires. Electrical or electronic apparatus may be provided with connector components suitable for mating with the connector components of the cabling structure to facilitate easy connection and disconnection with the cabling structure.

Preferably the cabling structure is constructed to be washable without sustaining damage from the washing process. The washing process can include a wet cleaning process, as is widespread in the home environment, or a dry cleaning process.

The cabling structure may further comprise a fabric carrier piece configured for incorporation into a garment and on which the remainder of the cabling structure is carried. The inclusion of a fabric carrier piece allows the pre-fabrication of a cabling structure which can be subsequently incorporated into a garment using traditional fabric construction techniques to attach the fabric carrier piece to the garment. Advantageously, this permits construction of a garment which includes the pre-fabricated cabling structure using standard production facilities and workforce skills normally found within the garment construction industry.

The present invention will now be described, by way of example only, with reference to the accompanying drawings in which:

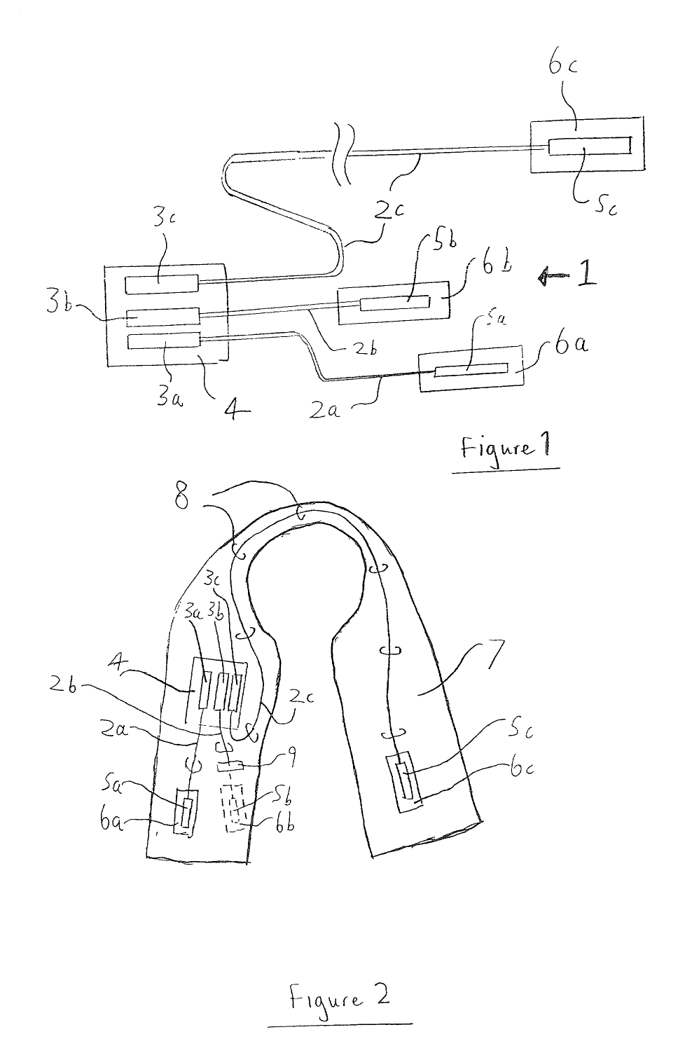

FIG. 1 shows a first embodiment of a transmission cabling structure made in accordance with the present invention;

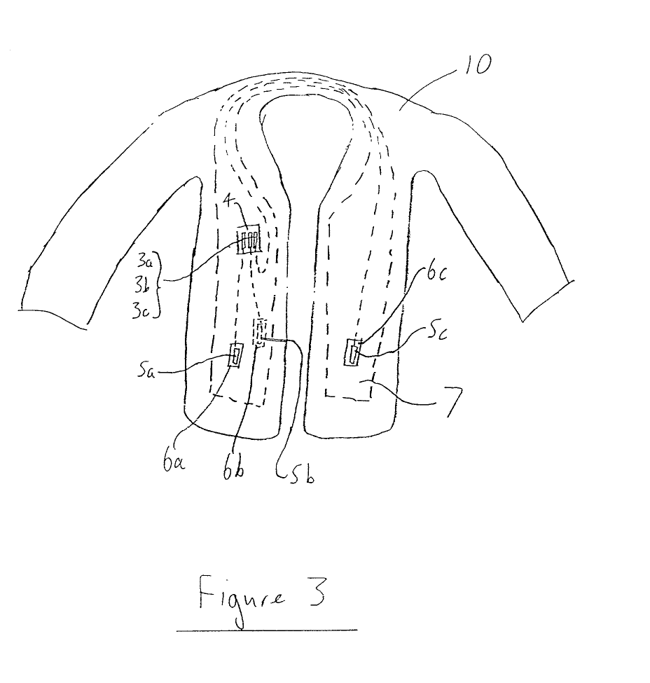

FIG. 2 shows a second embodiment of a transmission cabling structure made in accordance with the present invention; and

FIG. 3 shows a garment incorporating the transmission cabling structure of FIG. 2.

Referring to FIG. 1, a transmission cabling structure 1 includes three cable portions 2a, 2b, 2c each terminating at one end at cabling first terminals 3a, 3b, 3c respectively. In this example each of these terminations is mounted on a common fabric portion 4. Each cable portion 2a, 2b, 2c terminates at it's other end at cable terminations 5a, 5b, 5c respectively. In this example each of these terminations is mounted on an individual fabric portion 6a, 6b, 6c respectively.

By mounting cable terminations on fabric portions, the fabric portions and therefore cable terminations can be attached to a garment using construction techniques known in the garment construction industry. Such techniques include sewing, the use of fastening components and the use of adhesive. The use of the term fabric portions in this context may be understood to include woven, knitted, rolled or felted material and other such materials. Indeed, the fabric parts 4, 6a, 6b, 6c could be of any woven, non-woven, natural or man-made sheet material suitable for use in garment construction processes.

The cabling portions are internally routed around the garment and may be guided using, for example, loops, tubing, conduits. Guiding may also be achieved using guides formed by selectively stitching together regions of garment lining.

The cable portions preferably include one or more electrical conductors and/or optical fibres. The cable may be screened to block electromagnetic interference. In the most basic form, cable portions may terminate to expose the one or more electrical conductors and/or optical fibres. However, in this example the cable terminations are each provided with an electrical connector component suitable for mating with electrical connectors associated with electrical or electronic apparatus. In some situations connector adapter arrangements may be employed allowing electronic equipment with conventional connectors to be connected with the structure of the present invention. Preferably the electrical connector components facilitate easy connection and disconnection. One example of an electrical connector component includes the use of so-called press-studs or pop fasteners, as are widespread within the garment construction industry. The electrical connector component may instead be replaced with an optical connector component. The connector component may comprise of both electrical and optical connectors.

Referring to FIG. 2, the transmission cabling and structure of FIG. 1 is shown but now provided with a fabric carrier piece 7. The carrier piece is preferably constructed of a fabric material but may alternatively be of a non-fabric material that is suitable for incorporation into a garment, such as flexible sheet material. The carrier piece is configured for incorporation into a garment. The carrier piece of this example is for incorporation into a jacket which results in a saddle-like shape appearance. One or more of the fabric portions 4, 6a, 6b, 6c may be attached directly to the carrier piece 7, although in this example they are not. However, the carrier piece 7 may be provided with retaining means in the form of loops 8 for holding the cable portions 2a, 2b, 2c. The loops may be of elasticated or non elastic fabric, formed from Velcro ™ or be formed of sewing thread or the like. The fabric carrier piece 7 is provided with an aperture 9 allowing cable portion 2b to pass from one side of the carrier piece 7 to the other. The aperture may be provided using standard fabric construction techniques and in this case is provided as a button hole.

Referring to FIG. 3, internal components which are not visible from the outside of the jacket are shown with broken lines for clarity. Broken lines illustrate the placement of the cabling structure 1, including the carrier piece 7 within a jacket 10. The first cabling terminations 3a, 3b, 3c and cable terminations 5a and 5c are shown with solid lines because these are accessible from the exterior of the jacket for use. Cabling termination 5b is also accessible but from the inside of the jacket. Each termination is fastened to the jacket by stitching the termination fabric portions 4, 6a, 6b, 6c directly to the garment using fabric construction techniques readily available within the garment construction industry. The terminations may be temporarily covered by providing garment flap portions or the like. Advantageously, the arrangement provides a comfortable and robust solution with the wiring placed in a way to avoid annoyance and provide distribution of weight. Other arrangements and placements are possible as will be understood by the person skilled in the art. For example the number of cables and connectors may be varied, as may be the placement of the cables and connectors. The cabling structure may be included in other garments such as trousers and clothing accessories such as scarves, headgear or the like. Indeed when more than one garment is provided with the cabling structure the garments may be connected together as will be apparent to the person skilled in the art. The cabling structure may include one or more antenna component suitable for use with a radio receiver, mobile telephone or Global Positioning System information receiver or other such wireless applications. The electrical or electronic devices can include personal audio equipment, mobile telecommunications apparatus, personal digital assistants, location establishing equipment, wearable computing equipment and input/output devices.

From reading the present disclosure other modifications will be apparent to the person skilled in the art. Such modifications may involve other features which are already known in the design, manufacture and use of systems and devices and component parts thereof and which may be used instead of or in addition to features already described herein.

1. A transmission cabling structure for use in garments, said structure including at least one cable portion and at least one cabling termination wherein the termination is mounted on a fabric portion.

2. The cabling structure of claim 1 wherein the at least one termination comprises a connector component.

3. The cabling structure of claim 2 wherein the connector component facilitates electrical connection to be established with an at least one of the cabling portions.

4. The cabling structure of claim 2 wherein the connector component facilitates optical connection to be established with the at least one cabling portions.

5. The cabling structure of claim 1 wherein the cabling structure is constructed to be washable without sustaining damage.

6. The cabling structure of claim 2 wherein the cabling structure is constructed to be washable without sustaining damage.

7. The cabling structure of claim 1 and further comprising a fabric carrier piece shaped to facilitate incorporation into a garment and attached over at least a part of it's length to the or each cable portion.

8. The cabling structure of claim 2 and further comprising a fabric carrier piece shaped to facilitate incorporation into a garment and attached over at least a part of it's length to the or each cable portion.

9. The cabling structure of claim 7 wherein the carrier piece is attachable to a garment using conventional garment construction techniques.

10. The cabling structure of claim 1 and further comprising an antenna.

11. A garment comprising the transmission cabling structure of claim 1.

12. A garment comprising the transmission cabling structure of claim 2.

13. A garment comprising the transmission cabling structure of claim 3.

14. A garment comprising the transmission cabling structure of claim 4.

15. A garment comprising the transmission cabling structure of claim 5.

16. A garment comprising the transmission cabling structure of claim 6.

17. A garment comprising the transmission cabling structure of claim 7.

18. A garment comprising the transmission cabling structure of claim 8.

19. A garment comprising the transmission cabling structure of claim 9.

20. A garment comprising the transmission cabling structure of claim 10.
